(19) United States
(12) Patent Application Publication
(10) Pub. No.: US 2019/0012400 A1
(43) Pub. Date: Jan. 10, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Saneyuki KOBAYASHI, Kanagawa (JP); Kenichi NUMATA, Kanagawa (JP)

(73) Assignee: FUJI XEROX CO., LTD., Tokyo (JP)

(21) Appl. No.: 16/014,269

(22) Filed: Jun. 21, 2018

(30) Foreign Application Priority Data
Jul. 5, 2017 (JP) 2017-131612

(51) Int. Cl. G06F 17/30; G06F 17/24; G06F 9/451

(52) U.S. Cl. CPC G06F 17/30882; G06F 9/453; G06F 17/241

(57) ABSTRACT

A non-transitory computer readable medium stores a program causing a computer to execute a process. The process includes: receiving addition of a file representing information for providing a change to be made to an element forming a digital document to be read; managing the information by linking the information with the digital document; and presenting the digital document in which the information is reflected.

### CROSS-REFERENCE TO RELATED APPLICATIONS

This application is based on and claims priority under 35 USC 119 from Japanese Patent Application No. 2017-131612 filed Jul. 5, 2017.

### BACKGROUND

### (i) Technical Field

The present invention relates to an information processing apparatus and a non-transitory computer readable medium.

### (ii) Related Art

Webpages are now utilized for sharing information.

### SUMMARY

According to an aspect of the invention, there is provided a non-transitory computer readable medium storing a program causing a computer to execute a process. The process includes: receiving addition of a file representing information for providing a change to be made to an element forming a digital document to be read; managing the information by linking the information with the digital document; and presenting the digital document in which the information is reflected.

### BRIEF DESCRIPTION OF THE DRAWINGS

Exemplary embodiments of the present invention will be described in detail based on the following figures, wherein:

FIG. 1 illustrates an example of the configuration of a reading system according to an exemplary embodiment;

FIG. 2 illustrates an example of the hardware configuration of each of a management server and a manual server;

FIG. 3 illustrates an example of the functional configuration of the management server;

FIG. 4 illustrates an example of comment management data stored in a comment management database (DB);

FIG. 5 illustrates an example of an additional information table used for analysis conducted by an additional information analyzer;

FIG. 6 illustrates an example of additional information management data stored in an additional information management DB;

FIG. 7 illustrates an example of the functional configuration of the manual server;

FIG. 8 is a flowchart illustrating an example of processing executed by the management server;

FIG. 9 illustrates an example of a user interface screen used for receiving information;

FIG. 10 illustrates a display example of an input screen provided for assisting in inputting of additional information which represents an instruction to make a style change;

FIG. 11 illustrates an example of another input screen provided for assisting in inputting of four types of additional information;

FIG. 12 illustrates an example of a cascading style sheets (CSS) file created based on information input by using an input screen;

FIG. 13 illustrates an example of an input screen provided for assisting in inputting of additional information which represents an instruction to perform partial-page replacement;

FIG. 14 illustrates an example of another input screen provided for assisting in inputting of additional information which represents an instruction to perform partial-page replacement;

FIG. 15 illustrates an example of a hypertext markup language (html) file created based on information input by using an input screen;

FIG. 16 illustrates an example of another input screen provided for assisting in inputting of additional information which represents an instruction to perform entire-page replacement;

FIG. 17 illustrates an example of a page to be displayed after replacement;

FIG. 18 illustrates a display example of an input screen used for providing a script as additional information;

FIG. 19 illustrates a display example of another input screen used for providing a script as additional information;

FIG. 20 illustrates an example of a script file created based on information input by using an input screen;

FIG. 21 illustrates an example of a register screen used for receiving an application range;

FIG. 22 is a flowchart illustrating an example of processing executed by the manual server;

FIG. 23A illustrates an example of a user interface screen of an authorized user when additional information concerning a style change is appended to an accessed page;

FIG. 23B illustrates an example of a user interface screen of an unauthorized user when additional information concerning a style change is appended to an accessed page;

FIG. 24A illustrates an example of a user interface screen of an authorized user when additional information concerning partial-page replacement is appended to an accessed page;

FIG. 24B illustrates an example of a user interface screen of an unauthorized user when additional information concerning partial-page replacement is appended to an accessed page;

FIG. 25A illustrates an example of a user interface screen of an authorized user when additional information concerning entire-page replacement is appended to an accessed page;

FIG. 25B illustrates an example of a user interface screen of an unauthorized user when additional information concerning entire-page replacement is appended to an accessed page;

FIG. 26A illustrates an example of a user interface screen of an authorized user when additional information concerning a script is appended to an accessed page; and

FIG. 26B illustrates an example of a user interface screen of an unauthorized user when additional information concerning a script is appended to an accessed page.

### DETAILED DESCRIPTION

Exemplary embodiments of the invention will be described below in detail with reference to the accompanying drawings.

### Exemplary Embodiment

### (System Configuration)

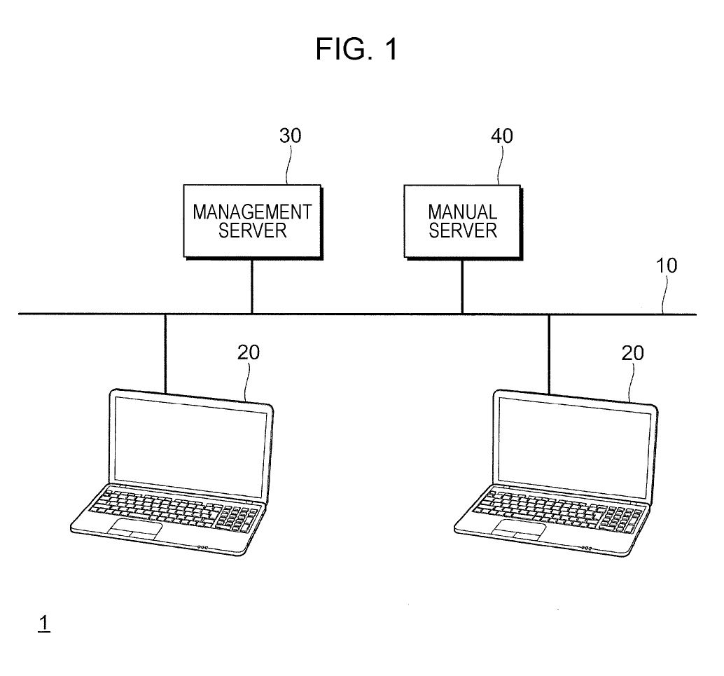

FIG. 1 illustrates an example of the configuration of a reading system 1 according to an exemplary embodiment.

The reading system 1 includes a network 10, terminals 20, a management server 30, and a manual server 40. The terminals 20 are operated by users. The management server 30 manages a change to be made to a digital manual to be read. The manual server 40 provides a digital manual to a terminal 20 which has accessed this digital manual.

The network 10 is a local area network (LAN) or the Internet, for example.

The terminal 20 may be any type of device including a display device and having a function of connecting to the network 10. Examples of the terminal 20 are information devices, such as a laptop computer, a smartphone, and a game machine.

The management server 30 has the functions of: receiving the addition of a file representing additional information for providing a change to be made to an element forming a page of a digital manual; receiving a range of users to be permitted to read the digital manual in which the additional information is reflected; and managing the additional information by linking the additional information and the range of users with the digital manual.

The management server 30 according to this exemplary embodiment also has the functions of: receiving the addition of a comment to a page of a digital manual; receiving a range of users to be permitted to read the comment; and linking the comment and the range of users with the digital manual.

Details of the individual functions will be discussed later.

The manual server 40 is a server that provides a digital manual to a terminal 20 via the network 10. The digital manual is an example of a digital document.

The manual server 40 has the functions of: judging whether additional information is linked with a digital manual to be read; judging whether a subject user is an authorized user permitted to read the additional information linked with the digital manual (more specifically, the digital manual in which the additional information is reflected); and presenting the digital manual to the user in accordance with the judging results.

Details of the individual functions will be discussed later.

In this exemplary embodiment, examples of an element forming a page of a digital manual are characters, phrases, sentences, drawings, photos, part of a page, and the entirety of a page.

A comment is information which does not provide a change to an element forming a page of a digital manual. A comment is added to a page as a popup or a note, which will be discussed later.

In this exemplary embodiment, the management server 30 and the manual server 40 are separately provided. However, the management server 30 and the manual server 40 may be formed as a single server.

In this exemplary embodiment, if authorized users and unauthorized users are not distinguished from each other, a user reading a digital manual will be called a “reader”.

### (Configuration of Server)

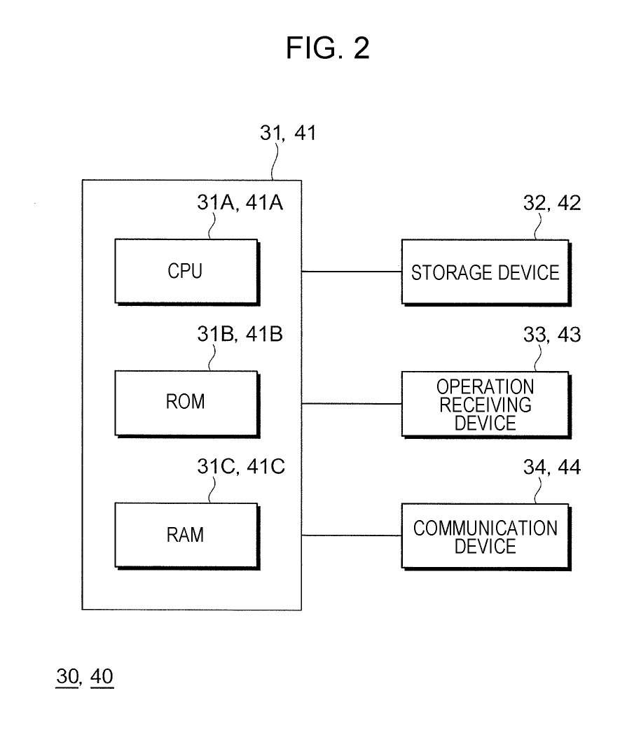

FIG. 2 illustrates an example of the hardware configuration of each of the management server 30 and the manual server 40.

Both of the management server 30 and the manual server 40 are configured based on a computer. Each of the management server 30 and the manual server 40 is an example of an information processing apparatus.

The management server 30 includes a signal processor 31, a storage device 32, an operation receiving device 33, and a communication device 34. The signal processor 31 executes receiving processing of additional information and the range of users to be permitted to read the additional information. The storage device 32 stores various programs and data. The operation receiving device 33 is used for receiving operation performed by an operator. The communication unit 34 sends and receives data to and from an external device.

The manual server 40 includes a signal processor 41, a storage device 42, an operation receiving device 43, and a communication device 44. The signal processor 41 executes sending processing of a page of a digital document to be read. The storage device 42 stores various programs and data. The operation receiving device 43 is used for receiving operation performed by an operator. The communication unit 44 sends and receives data to and from an external device.

The signal processor 31 includes a central processing unit (CPU) 31A, a read only memory (ROM) 31B, and a random access memory (RAM) 31C. The signal processor 41 includes a CPU 41A, a ROM 41B, and a RAM 41C. The CPUs 31A and 41A execute programs. The ROMs 31B and 41B store startup programs, for example. The RAMS 31C and 41C are used as work areas.

The storage devices 32 and 42 are constituted by hard disk drives, for example. The storage device 32 may alternatively be an external device connected to the management server 30 via the communication device 34. Likewise, the storage device 42 may alternatively be an external device connected to the manual server 40 via the communication device 44.

Examples of the operation receiving devices 33 and 43 are a keyboard, a mouse, and a touchscreen. The operation receiving devices 33 and 43 are used for inputting information and instructions to a user interface screen displayed on a display device, which is not shown.

Examples of the communication devices 34 and 44 are a universal serial bus (USB) interface and a network interface.

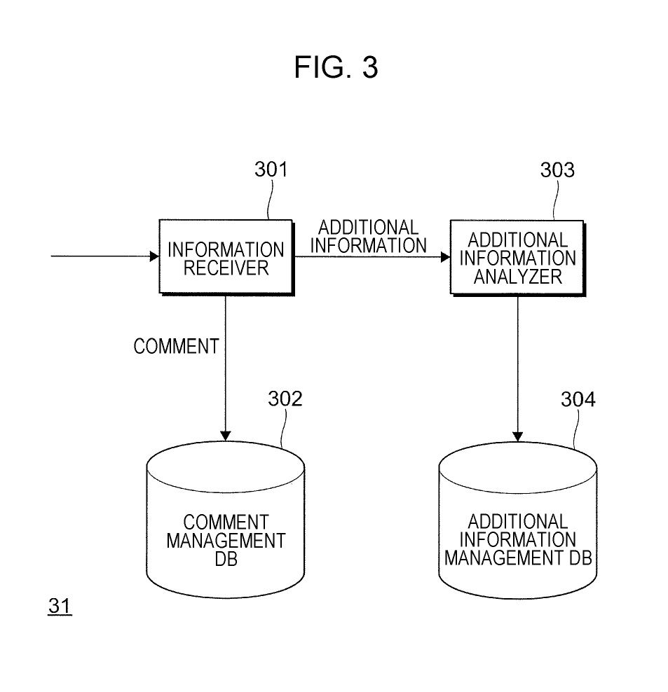

FIG. 3 illustrates an example of the functional configuration of the management server 30.

The functional configuration shown in FIG. 3 is implemented as a result of the signal processor 31 executing a program.

In this exemplary embodiment, the signal processor 31 includes an information receiver 301, a comment management database (DB) 302, an additional information analyzer 303, and an additional information management DB 304. The information receiver 301 receives input of a comment or additional information selected by a user. The comment management DB 302 manages comments. The additional information analyzer 303 analyzes the type of additional information. The additional information management DB 304 manages additional information.

The information receiver 301 receives a comment or additional information via a user interface screen, which will be discussed later. The information receiver 301 may receive plural items of additional information. The plural items of additional information are not necessarily of the same type and may be of different types.

The position of a comment to be added is selected by a user. The comment is displayed on a page forming a digital manual as a popup or a note. Plural comments may be input.

The information receiver 301 which provides the function of receiving a comment is an example of a receiver. The information receiver 301 which provides the function of receiving additional information is an example of the receiver.

The information receiver 301 stores a received comment in the comment management DB 302. The information receiver 301 which provides the function of storing a received comment is an example of a manager.

In this exemplary embodiment, additional information is information for providing a change to be made to an element forming a page. Examples of the information are a style change, partial-page replacement, entire-page replacement, and a script.

The style change is information for providing a change to be made to a display color, such as the color of characters, a background color, a font type, and a font size.

Partial-page replacement is information for replacing a specific range within a page of a digital manual by the different content. In other words, partial-page replacement is information for replacing part of a page. Examples of objects to be replaced are characters, drawings, and photos.

Entire-page replacement is information for replacing the entirety of a page forming a digital manual. Partial-page replacement is to replace part of a page, while entire-page replacement is to replace the entirety of a page. In entire-page replacement, plural pages may be replaced by one page or plural pages, and plural pages may replace one page or plural pages.

A script is information for providing an instruction to make a change, such as a style change, partial-page replacement, or entire-page replacement, throughout the execution of a program.

In this exemplary embodiment, a style change, partial-page replacement, entire-page replacement, and a script accompanying such a change are examples of information for providing a change to be made to an element forming a page.

Plural items of additional information may be input in association with one comment. In this exemplary embodiment, “in association with” is also called “be linked with”.

The comment management DB 302 is implemented by part of the storage device 32 (see FIG. 2) or by an external storage device connected to the management server 30 via the communication device 34 (see FIG. 2).

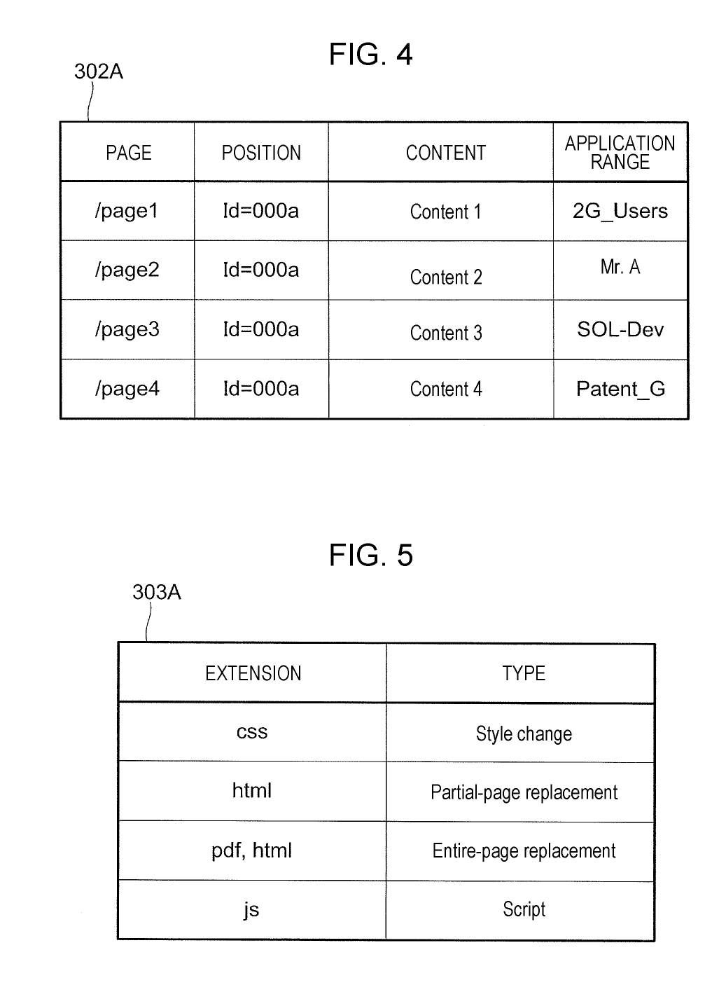

FIG. 4 illustrates an example of comment management data 302A stored in the comment management DB 302.

The comment management data 302A is provided for each digital manual to which comments are appended.

The comment management data 302A is constituted by a page to which a comment is appended, the position within the page, the content of the comment, and the range of users permitted to read the page in which the comment is reflected (application range).

In this exemplary embodiment, as examples of the application range, an individual user “Mr. A”, members of specific groups “2G_Users” and “Patent_G”, and a division “SOL-Dev” are indicated. The comment management data may not necessarily indicate information concerning the application range.

Referring back to FIG. 3, the additional information analyzer 303 provides the functions of: analyzing the type of additional information by using an extension of a file provided as the additional information; and storing the additional information in the additional information management DB 304 based on the analyzing result.

The additional information analyzer 303 is an example of the manager.

In some cases, additional information is input into the information receiver 301 as a file appended with a predetermined extension. In other cases, additional information is input as a result of inputting information into a user interface screen, which will be discussed later, and then, a file is generated.

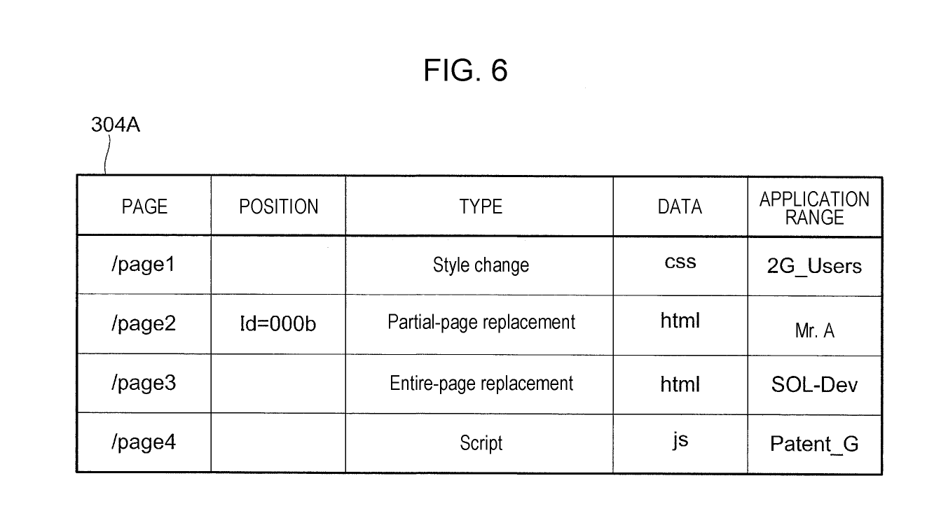

FIG. 5 illustrates an example of an additional information table 303A to be used by the additional information analyzer 303 to analyze the type of additional information.

In the additional information table 303A, the association between a file extension and the type of additional information is stored. In the example in FIG. 5, “css” is associated with a style change, “html” is associated with partial-page replacement, “pdf” and “html” are associated with entire-page replacement, and “js” is associated with a script.

In the case of “html”, if the position within a page is specified, the additional information analyzer 303 determines that the type of additional information is partial-page replacement, and if the position within a page is not specified, the additional information analyzer 303 determines that the type of additional information is entire-page replacement.

Referring back to FIG. 3, the additional information management DB 304 is implemented by part of the storage device 32 (see FIG. 2) or by an external storage device connected to the management server 30 via the communication device 34 (see FIG. 2).

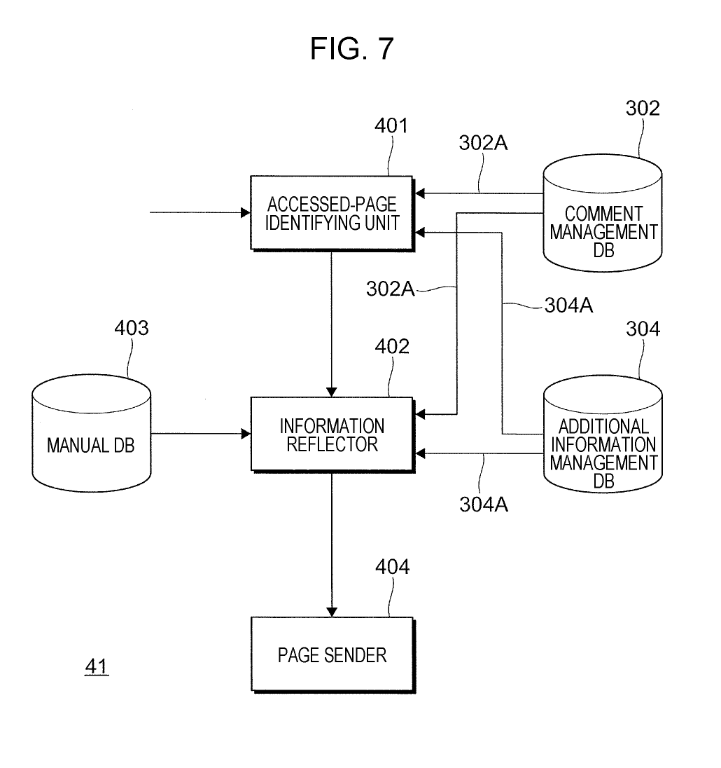

FIG. 6 illustrates an example of additional information management data 304A stored in the additional information management DB 304. The additional information management data 304A, as well as the comment management data 302A, is provided for each digital manual to which comments are appended. This is because, in this exemplary embodiment, additional information is registered in association with the operation of adding a comment.

The additional information management data 304A is constituted by a page to which additional information is appended, the position within the page, the type of additional information, file data, and the range of users permitted to read the page in which the additional information is reflected (application range).

In this exemplary embodiment, the application range of additional information and that of a comment are the same range. However, the two application ranges may partially or entirely be different from each other.

The functional configuration of the manual server 40 will be described below.

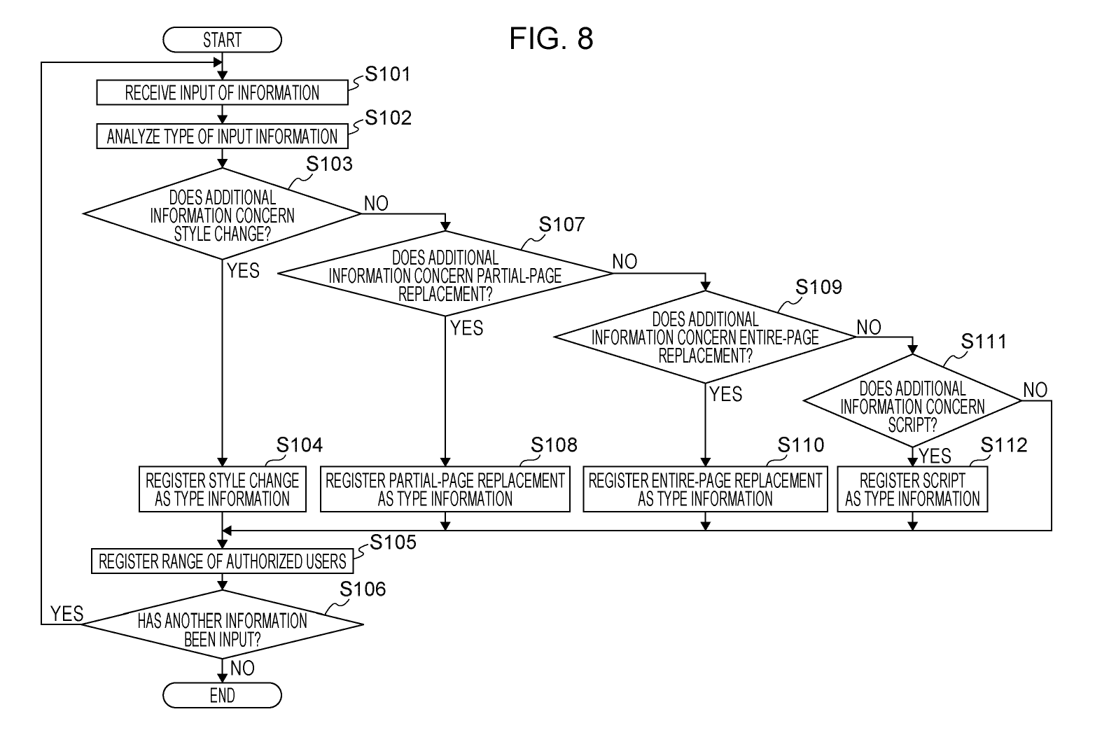

FIG. 7 illustrates an example of the functional configuration of the manual server 40.

The functional configuration shown in FIG. 7 is implemented as a result of the signal processor 41 executing a program.

In this exemplary embodiment, the signal processor 41 includes an accessed-page identifying unit 401, an information reflector 402, a manual DB 403, and a page sender 404. The accessed-page identifying unit 401 identifies a page accessed from a user. The information reflector 402 causes information appended to an accessed page to be reflected in this page. The manual DB 403 stores digital data representing a digital manual. The page sender 404 sends a page accessed from a user to this user.

The accessed-page identifying unit 401 identifies a page of a digital manual to be read, based on access information supplied via a web browser of the terminal 20.

The information reflector 402 has the functions of: checking for information linked with a page to be read; judging, if such information is linked with the page, whether a reader is allowed to read the page in which the information is reflected; and generating a page to be read by the reader in accordance with the judging result.

The information reflector 402 refers to the comment management data 302A (see FIG. 4) in the comment management DB 302 and the additional information management data 304A (see FIG. 6) in the additional information management DB 304 so as to check for a comment or additional information appended with a page to be read.

The information reflector 402 which provides this function is an example of a first judging unit.

The information reflector 402 refers to the comment management data 302A (see FIG. 4) in the comment management DB 302 and the additional information management data 304A (see FIG. 6) in the additional information management DB 304 so as to judge whether a subject reader is allowed to read a page in which a comment or additional information is reflected.

The information reflector 402 which provides this function is an example of a second judging unit.

The comment management DB 302 and the additional information management DB 304 are an example of a storage area.

In this exemplary embodiment, if a comment or additional information is appended to a page to be read and if a subject reader is a user permitted to read the appended comment or additional information, the information reflector 402 causes the appended comment or additional information to be reflected in the page which is read from the manual DB 403 and supplies the resulting screen to the page sender 404.

In contrast, if no comment or additional information is appended to a page to be read or if a reader is not permitted to read a comment or additional information appended to the page, the information reflector 402 supplies this page to the page sender 404.

The information reflector 402 is an example of a presentation controller.

The manual DB 403 is implemented by part of the storage device 42 (see FIG. 2) or by an external storage device connected to the manual server 40 via the communication device 44 (see FIG. 2).

The page sender 404 presents the page received from the information reflector 402 to the subject reader.

### (Processing Operations)

Processing operations executed by the management server 30 and the manual server 40 will be described below.

(Processing Executed when Information is Registered)

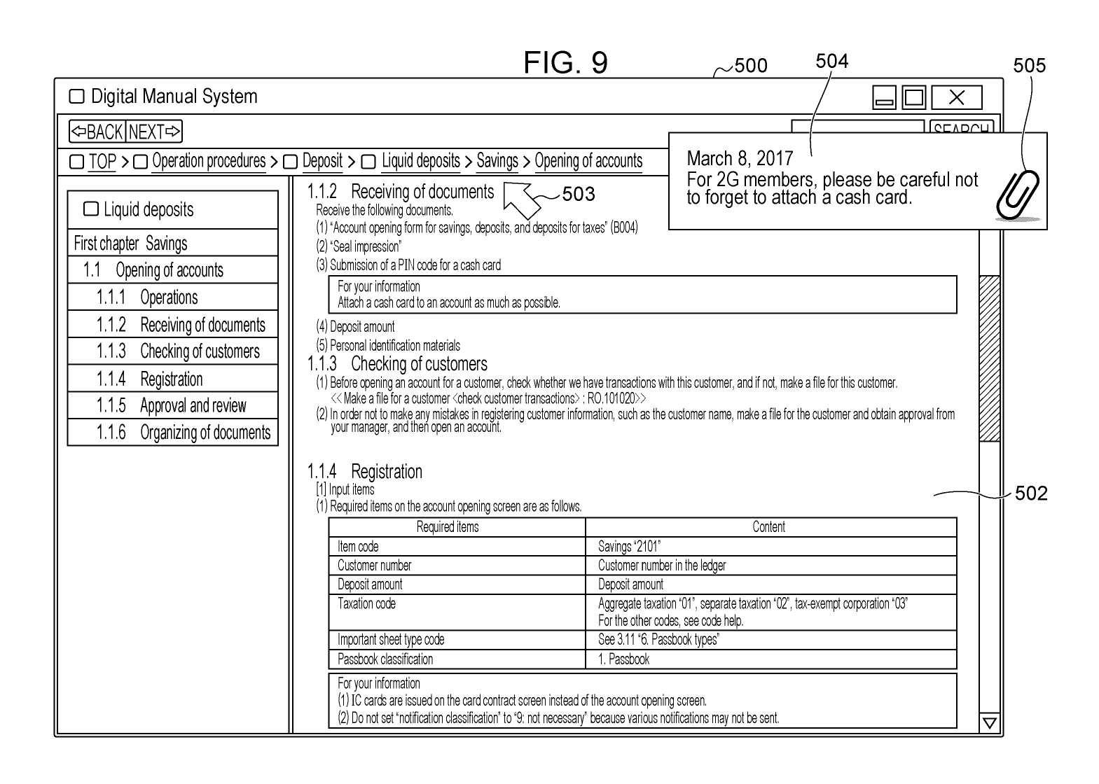

FIG. 8 is a flowchart illustrating an example of processing executed by the management server 30.

The processing shown in FIG. 8 is implemented by the functions of the information receiver 301 (see FIG. 3) and the additional information analyzer 303 (see FIG. 3) of the management server 30 (see FIG. 2).

In step S101, the information receiver 301 receives input of information from an operator.

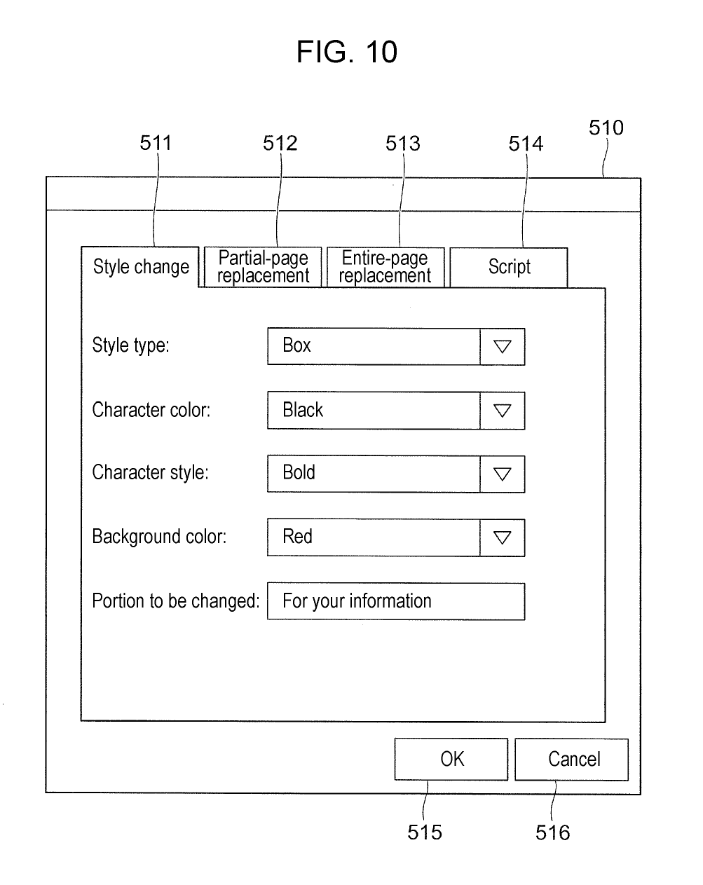

FIG. 9 illustrates an example of a user interface screen 500 used for receiving information.

On the user interface screen 500, part of a page 502 of a digital manual to be edited is displayed.

The operator of the digital manual selects a position within the page 502 by using a pointer 503. The operator then opens an input field 504 by a certain operation (by right clicking, for example), which is not shown, and inputs a comment.

In FIG. 9, a message “Mar. 8, 2017 (line break) For 2G members, please be careful not to forget to attach a cash card” is input as a comment.

In this exemplary embodiment, (line break) in a comment means that, after “line break”, a line is inserted before starting the next sentence or phrase (“For 2G members, please be careful not to forget to attach a cash card”).

The content of the comment input in the input field 504 in FIG. 9 is information for the members of the second group (2G) and is not necessary for the members of the other groups.

From this point of view, in this exemplary embodiment, the function of specifying a range of users to be permitted to read a page in which a comment is reflected is provided.

More specifically, an attach button 505 is provided in the input field 504.

The operator clicks the attach button 505, and then, an assist screen for assisting in inputting of additional information for providing a change to an element forming a page is displayed. By using the assist screen, the operator can input additional information without requiring expertise.

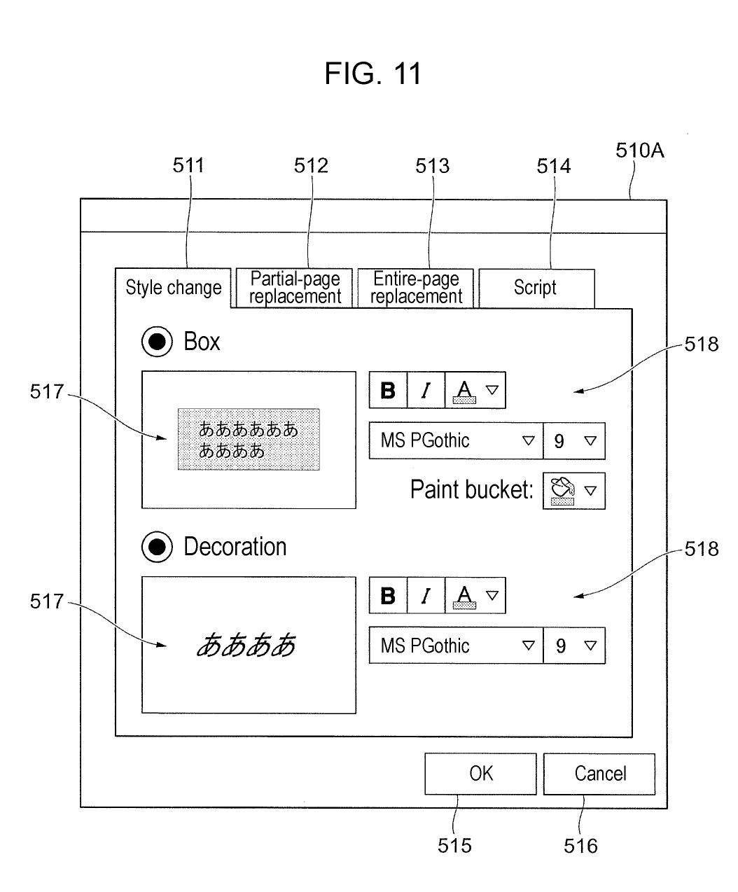

FIG. 10 illustrates a display example of an input screen 510 provided for assisting in inputting of additional information for providing an instruction to make a style change.

The input screen 510 is constituted by a style change page, a partial-page replacement page, an entire-page replacement page, and a script page. These pages are distinguished from each other by tabs.

On the input screen 510 in FIG. 10, the page corresponding to a style change tab 511 is opened. On the input screen 510, in addition to the style change tab 511, a partial-page replacement tab 512, an entire-page replacement tab 513, and a script tab 514 are displayed.

On the page corresponding to the style change tab 511, a style type, a character color, a character style, a background color, and a portion to be changed can be input.

In the example in FIG. 10, pull-down menus are provided for the style type, character color, character style, and background color, and a box, black, bold, and red are selected for the respective items of information.

In the example in FIG. 10, as information for specifying a portion to be changed, “for your information”, which is a title within the page 502 (FIG. 9), is selected. Alternatively, a portion to be changed may be specified by selecting a character string on the page 502 or by text input of a character string to be changed.

The operator clicks a set (OK) button 515 to set the content of input information or clicks a cancel button 516 to cancel the content of input information.

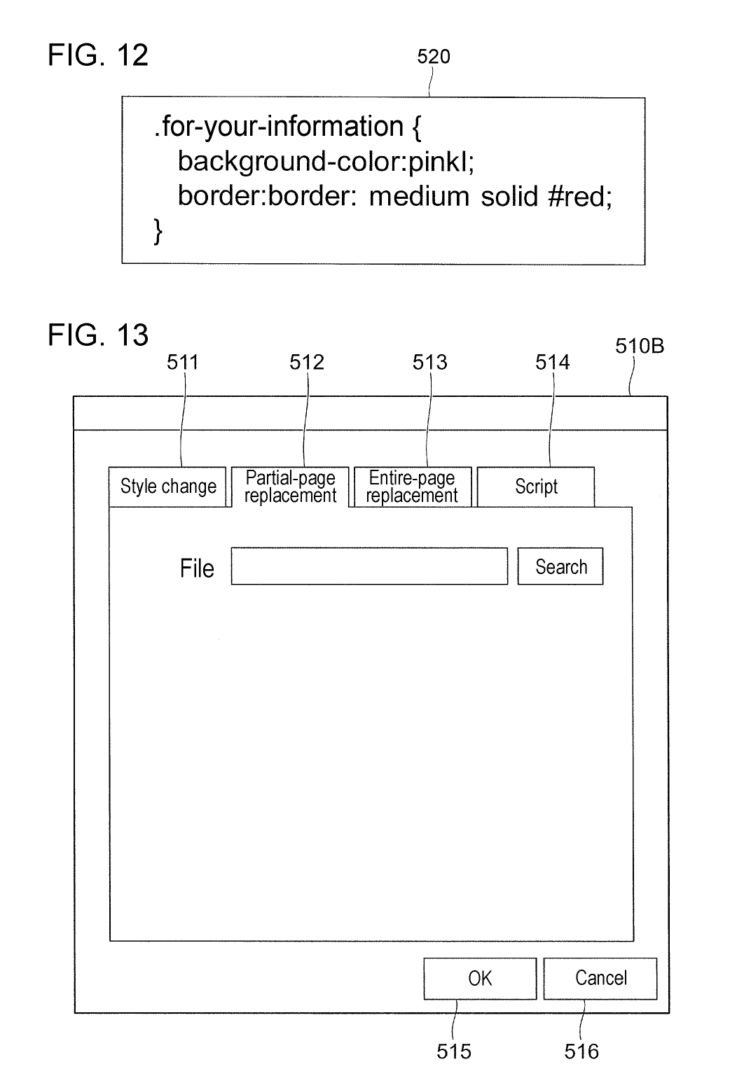

FIG. 11 illustrates an example of another input screen 510A provided for assisting in inputting of four types of additional information.

The input screen 510A shows an example of a page corresponding to a style change tab 511.

On the input screen 510A, for each of a box and a decoration, a preview screen field 517 and buttons 518 used for selecting character attributes are provided. In FIG. 11, the preview screen field 517 for the box is represented in a grayscale due to the limitations for the drawing system. On the actual screen, however, an image with a background color selected in a paint bucket field is displayed. The preview screen fields 517 and the buttons 518 are used in place of the pull-down menus in FIG. 10. On the input screen 510A, a portion to be changed is specified on the page 502.

In the case of the input screen 510A, the operator can input the content of a change to be made to a specified portion while checking an image showing the specified portion in which such a change is reflected.

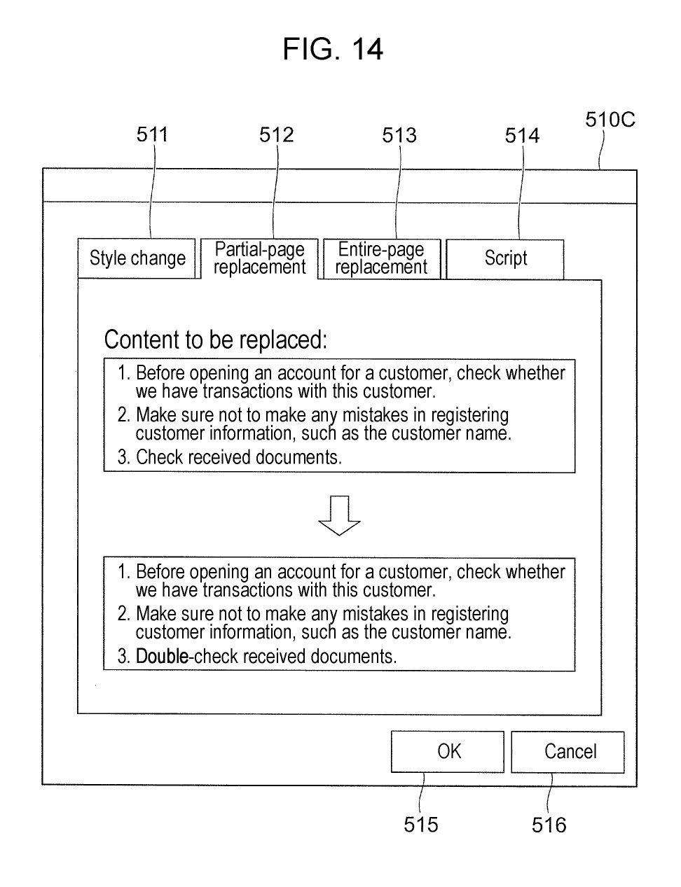

FIG. 12 illustrates an example of a cascading style sheets (CSS) file 520 created based on information input by using the input screen 510 or 510A.

In FIG. 12, the CSS file 520 describes that the background color of the character strings under the title “for your information” is changed to pink and that the border color is changed to red.

In this exemplary embodiment, the operator inputs the content of a change by using the input screen 510 in FIG. 10 or the input screen 510A in FIG. 11. Alternatively, the operator may directly input the content of a change, such as the description shown in FIG. 12 by using a style sheet. The operator may alternatively specify the created CSS file 520 as a file name.

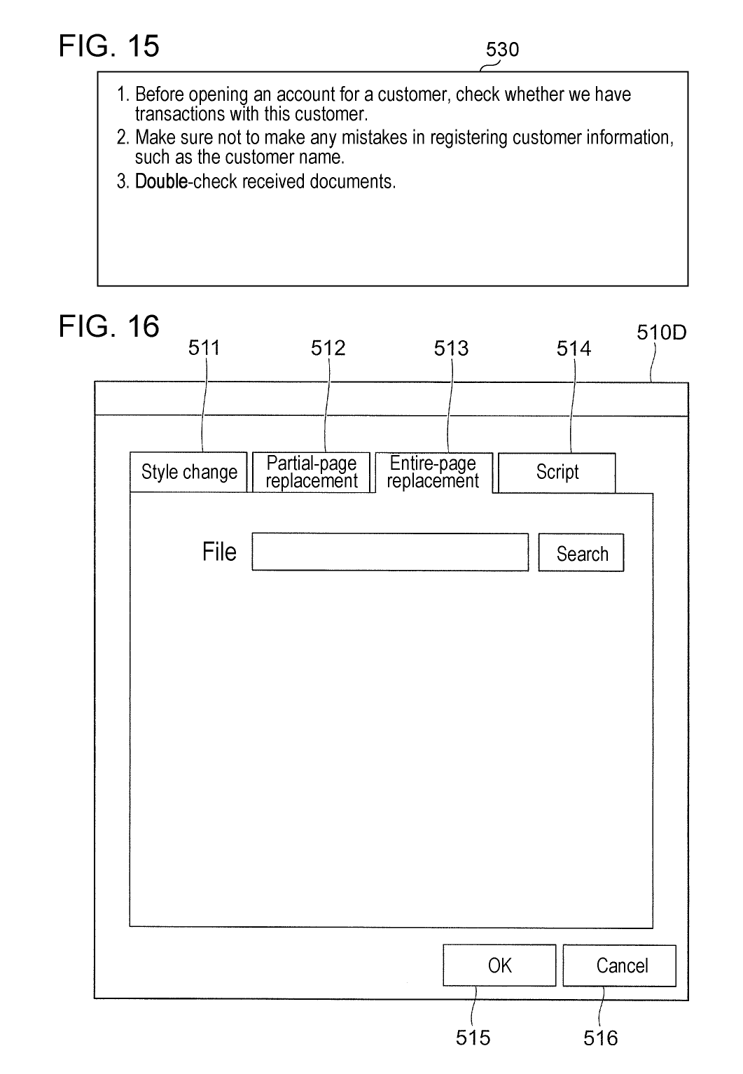

FIG. 13 illustrates an example of an input screen 510B provided for assisting in inputting of additional information for providing an instruction to perform partial-page replacement.

The input screen 510B is constituted by a style change page, a partial-page replacement page, an entire-page replacement page, and a script page. These pages are distinguished from each other by tabs.

On the input screen 510B in FIG. 13, the page corresponding to a partial-page replacement tab 512 is opened.

On the input screen 510B, in addition to the partial-page replacement tab 512, a style tab 511, an entire-page replacement tab 513, and a script tab 514 are displayed.

On the page corresponding to the partial-page replacement tab 512, the operator can specify a file name. In the example in FIG. 13, a pull-down menu is provided for a search button, and the operator can select one of the available file names. In this exemplary embodiment, partial-page replacement is conducted by using a hypertext markup language (html) file.

The operator clicks a set (OK) button 515 to set the content of input information or clicks a cancel button 516 to cancel the content of input information.

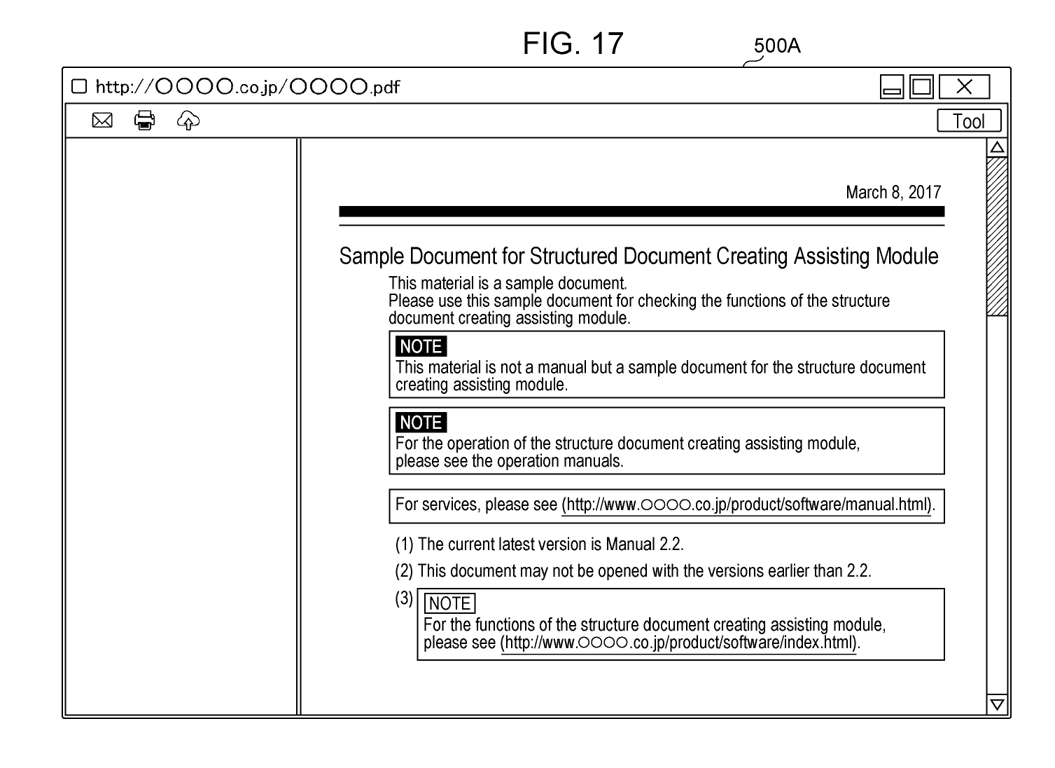

FIG. 14 illustrates an example of another input screen 510C provided for assisting in inputting of additional information for providing an instruction to perform partial-page replacement.

On the input screen 510C in FIG. 14, the page corresponding to a partial-page replacement tab 512 is opened.

On the input screen 510C, the operator can directly input the content of replacement. In the example in FIG. 14, a display field and an input field are provided. In the display field, the content of a portion to be replaced is displayed. In the input field, the content of the replaced portion is displayed.

In the case of the input screen 510C, the operator can input the content of replacement while checking the content of the selected portion to be replaced. In the example in FIG. 14, a description “3. Check received documents” has been changed to a description “3. Double-check received documents”. In this example, “check” is replaced by “double-check”.

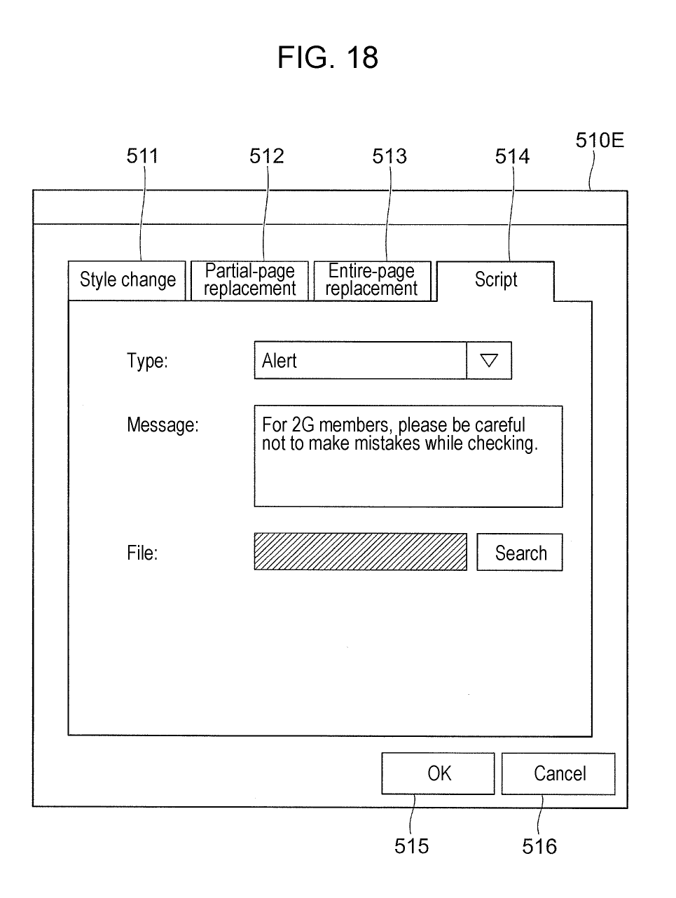

FIG. 15 illustrates an example of an html file 530 created based on information input by using the input screen 510B or 510C.

In the description of the replaced text, the font color of the description “3. Double-check received documents” is changed to red for attracting attention.

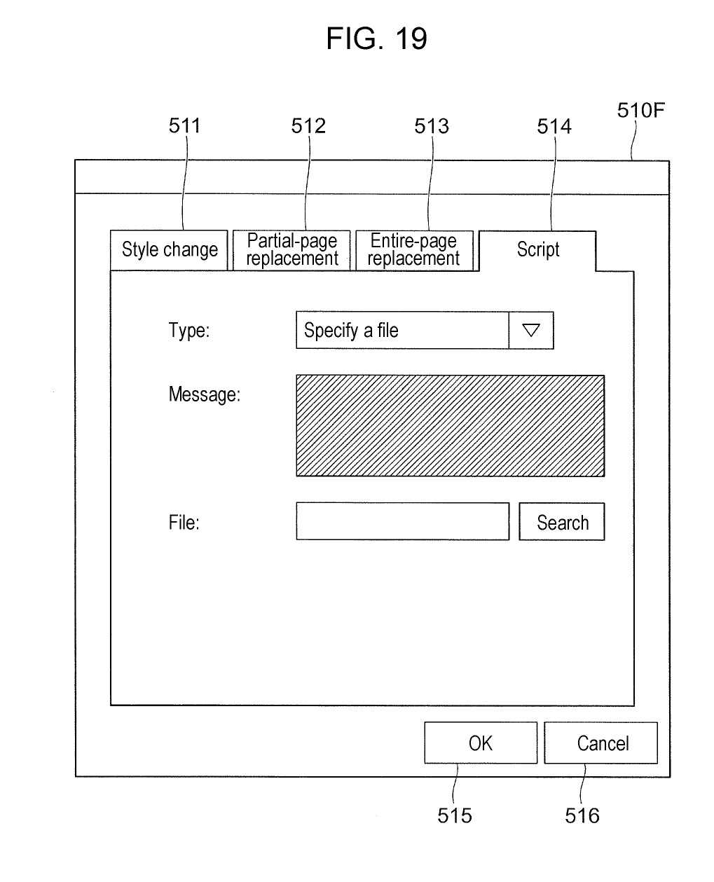

FIG. 16 illustrates an example of another input screen 510D provided for assisting in inputting of additional information for providing an instruction to perform entire-page replacement. In contrast to partial-page replacement, entire-page replacement is conducted in units of pages.

On the input screen 510D in FIG. 16, the page corresponding to an entire-page replacement tab 513 is opened.

In the case of the input screen 510D, the operator can specify the file name of a document having a page to be replaced by using a search button.

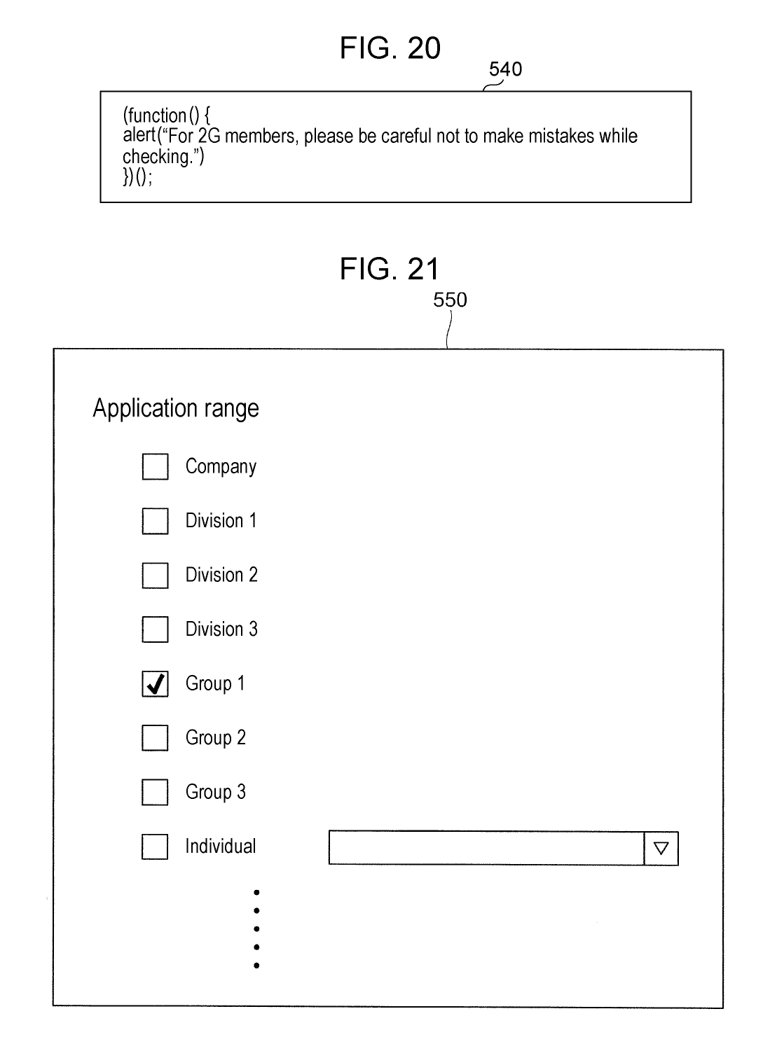

FIG. 17 illustrates an example of a page to be displayed after entire-page replacement is conducted. On a user interface screen 500A in FIG. 17, a page under a title “Sample document for structured document creating assisting module” is displayed. The content and layout of this page are different from those of the page displayed on the user interface screen 500 (see FIG. 9) before entire-page replacement is conducted.

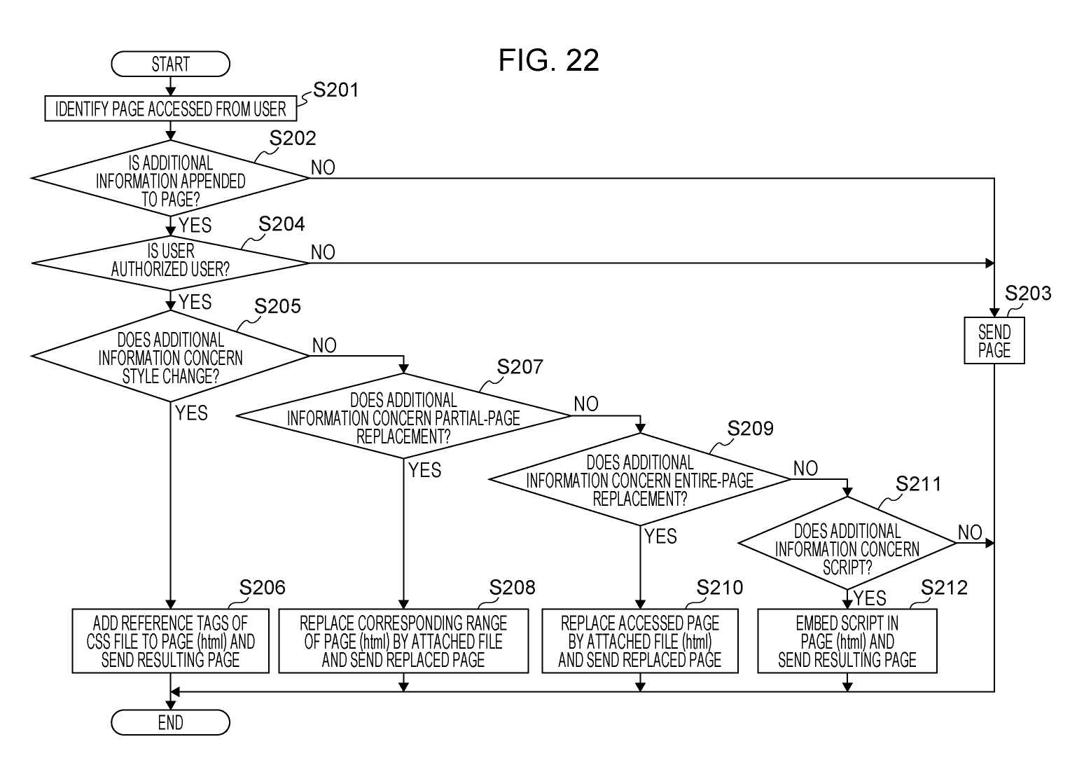

FIG. 18 illustrates a display example of an input screen 510E used for providing a script as additional information. The script is a simplified program. Not to mention the above-described style change, partial-page replacement, and entire-page replacement, the script can describe more complicated display. For example, display which changes over time can be described by using a script.

On the input screen 510E, the operator can select the type of script by using a pull-down menu. In this exemplary embodiment, the operator can select “alert” or “specify a file” by using the pull-down menu.

On the input screen 510E, “alert” has been selected as the type of script. In this example, the operator can input a message to be displayed into a message field. The message input into the message field is displayed as a popup on the user interface screen 500 (see FIG. 9).

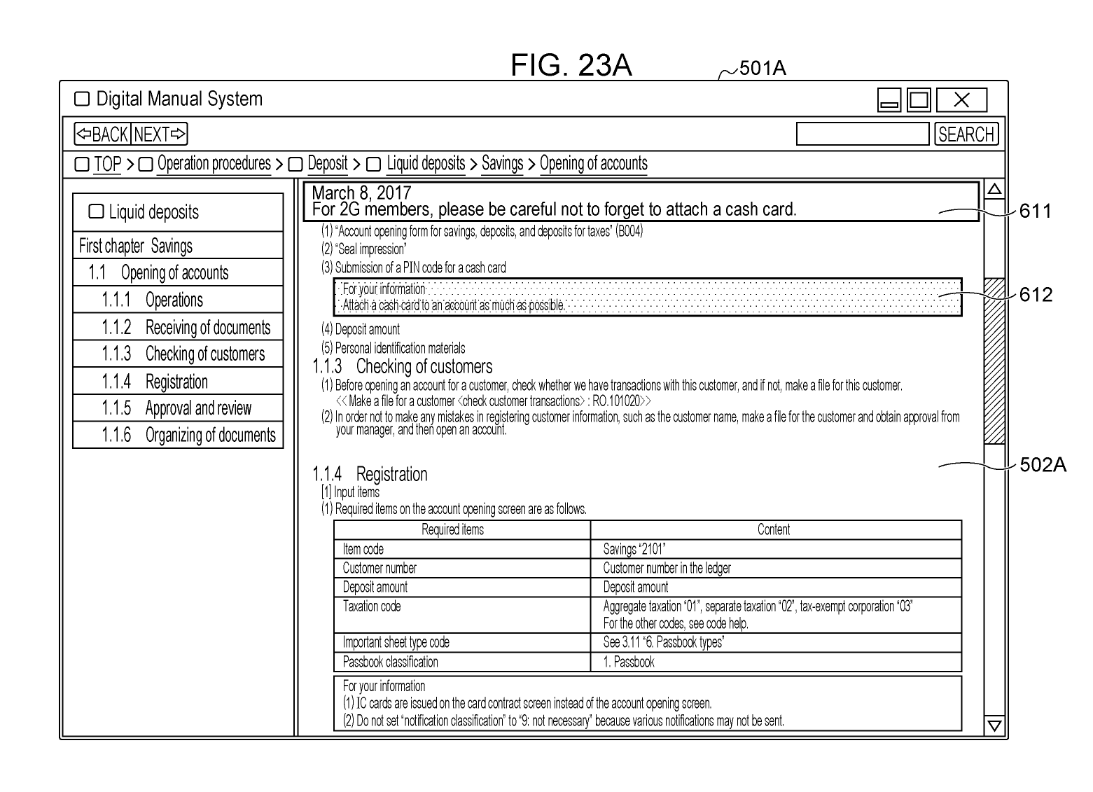

FIG. 19 illustrates a display example of another input screen 510F used for providing a script as additional information. In the example in FIG. 19, as the type of script, “specify a file” is selected.

On the input screen 510F, the operator can specify a script file name by using a search button. In this case, a message field is not available.

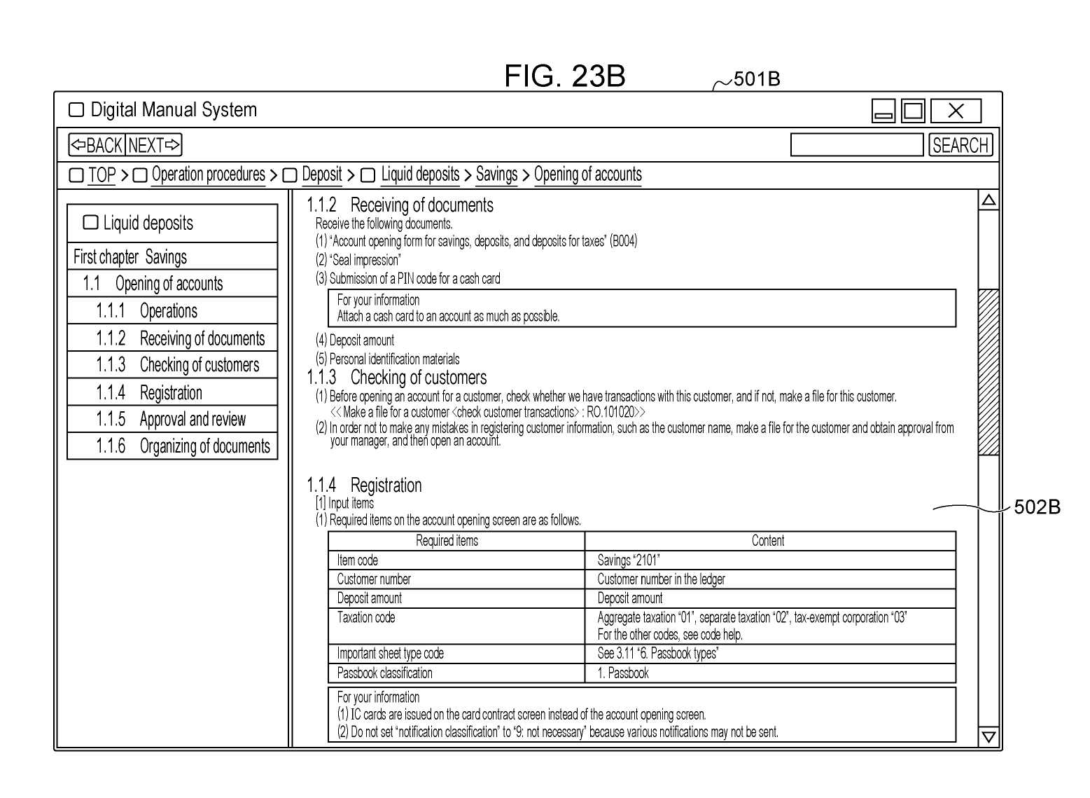

FIG. 20 illustrates an example of a script file 540 created based on information input by using the input screen 510E.

The script file 540 describes an instruction to display an alert message “For 2G members, please be careful not to make mistakes while checking” as a popup.

Referring back to FIG. 8, after receiving input of information from the operator in step S101 (see FIGS. 9 through 20), the signal processor 31 (see FIG. 3) of the management server 30 analyzes the type of input information in step S102.

In this exemplary embodiment, the additional information analyzer 303 (see FIG. 3) determines the type of additional information based on the extension of a file provided as the additional information. This determination is made based on the additional information table 303A (see FIG. 5). The file extension represents the type of additional information.

In this exemplary embodiment, as first judging processing, the additional information analyzer 303 judges in step S103 whether the additional information concerns a style change.

If the file extension is “css”, the additional information analyzer 303 judges that the additional information concerns a style change.

Then, in step S104, the additional information analyzer 303 registers a style change as type information. More specifically, the additional information analyzer 303 registers a style change in the additional information management data 304A (see FIG. 6) managed by the additional information management DB 304.

Then, in step S105, the additional information analyzer 303 registers the range of users to be permitted to read input information (authorized users). In this case, “information” includes, not only additional information, but also comments. However, registration of the range of authorized users may be separately conducted as registration concerning comments and that concerning additional information.

In this exemplary embodiment, when the range of authorized users concerning additional information is registered, it is assumed that the range of authorized users concerning comments is also registered.

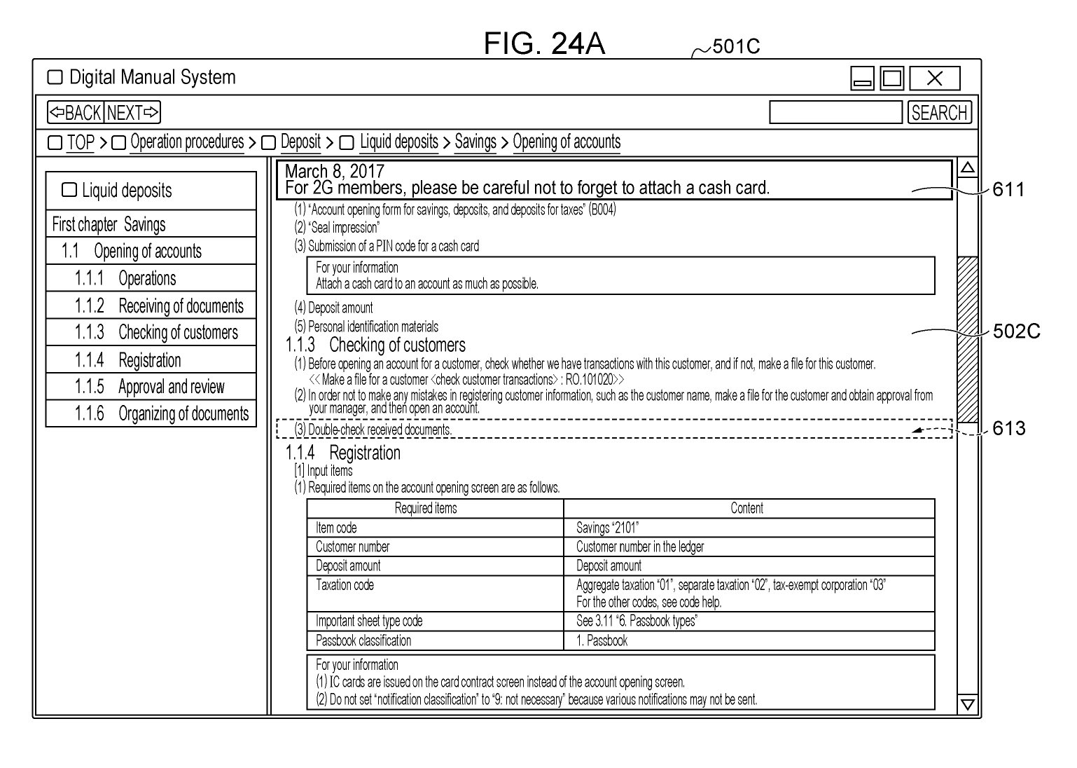

FIG. 21 illustrates an example of a register screen 550 used for receiving the range of users (application range). In this exemplary embodiment, the operator can specify the application range as one of or a combination of an individual, a group, an organization, a position in an organization, a project, a client, a terminal device, and position information.

On the register screen 550 in FIG. 21, a company, which is the largest range, a division 1, a division 2, and a division 3 forming the company, a group 1, a group 2, and a group 3 forming a division, and an individual, which is the smallest range, are displayed with check boxes. In this example, the group 1 is checked.

A check mark indicates that an associated item is being selected and items without a check mark are not being selected.

If no restrictions are imposed on reading of comments and additional information, the company, which is the largest range, is checked.

Using check boxes for registering authorized users enhances the efficiency of the input operation.

Referring back to FIG. 8, after step S105, the additional information analyzer 303 judges in step S106 whether another information has been input. In this exemplary embodiment, this judgement is made based on whether the user has provided an instruction to finish inputting additional information or an instruction to input another additional information by using an interface screen, which is not shown.

If the additional information analyzer 303 has judged in step S106 that another information has been input, it returns to step S101. If the additional information analyzer 303 has judged in step S106 that no information has been input, it completes the processing.

If the additional information analyzer 303 has judged in step S103 that the additional information does not concern a style change, it means that the type of additional information is other than a style change.

Then, the additional information analyzer 303 judges in step S107 whether the additional information concerns partial-page replacement.

If the file extension is “html” and if the position within a page is specified, the additional information analyzer 303 judges in step S107 that the additional information concerns partial-page replacement.

Then, in step S108, the additional information analyzer 303 registers partial-page replacement as type information. More specifically, the additional information analyzer 303 registers partial-page replacement in the additional information management data 304A (see FIG. 6) managed by the additional information management DB 304.

Then, in step S105, the additional information analyzer 303 registers the range of users to be permitted to read input information (authorized users) and judges in step S106 whether another information has been input.

If it is judged in step S107 that the additional information does not concern partial-page replacement, the additional information analyzer 303 judges in step S109 whether the additional information concerns entire-page replacement.

If the file extension is “html” or “pdf” and if the position within a page is not specified, the additional information analyzer 303 judges in step S109 that the additional information concerns entire-page replacement.

Then, in step S110, the additional information analyzer 303 registers entire-page replacement as type information.

Then, in step S105, the additional information analyzer 303 registers the range of users to be permitted to read input information (authorized users) and judges in step S106 whether another information has been input.

If it is judged in step S109 that the additional information does not concern entire-page replacement, the additional information analyzer 303 judges in step S111 whether the additional information concerns a script.

If the file extension is “js”, the additional information analyzer 303 judges in step S111 that the additional information concerns a script.

Then, in step S112, the additional information analyzer 303 registers a script as type information.

Then, in step S105, the additional information analyzer 303 registers the range of users to be permitted to read input information (authorized users) and judges in step S106 whether another information has been input.

If it is judged in step S111 that the additional information does not concern a script, the additional information analyzer 303 judges that additional information has not been input. For example, additional information has not been input, but a comment has been input.

In this case, the additional information analyzer 303 proceeds to step S105 to register a range of users to be permitted to read a comment (authorized users) and judges in step S106 whether another information has been input.

(Processing Executed when Access is Made)

Processing to be executed when a reader has accessed the manual server 40 by using a terminal 20 will be described below.

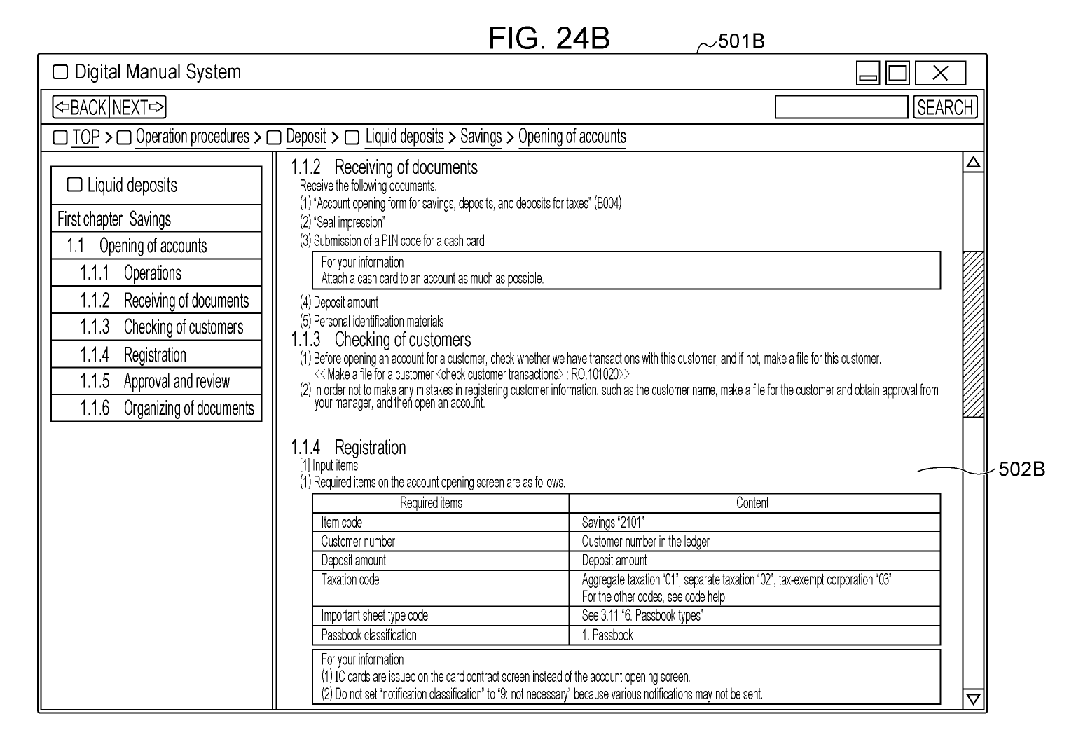

FIG. 22 is a flowchart illustrating an example of processing executed by the manual server 40.

The processing shown in FIG. 22 is implemented by using processing functions of the manual server 40 (see FIG. 2) (accessed-page identifying unit 401 (see FIG. 7), information reflector 402 (see FIG. 7), and page sender 404 (see FIG. 7)).

In step S201, the accessed-page identifying unit 401 identifies a page accessed from the user.

In step S202, the accessed-page identifying unit 401 judges whether additional information is appended to the accessed page, based on one or both of the comment management data 302A (see FIG. 4) and the additional information management data 304A (see FIG. 6).

If it is judged in step S202 that no additional information is appended to the page, the information reflector 402 proceeds to step S203 to read the page from the manual DB 403 and send the read page.

In this case, the same content of the page is displayed on all the terminals 20.

If it is judged in step S202 that additional information is appended to the accessed page, the information reflector 402 determines in step S204 whether the user (reader) is an authorized reader permitted to read the additional information.

If it is judged in step S204 that the user is not an authorized reader, the information reflector 402 sends the page without appending the additional information in step S203.

If it is judged in step S204 that the user is an authorized reader, the information reflector 402 judges in step S205 whether the additional information concerns a style change.

In this exemplary embodiment, judging processing for the comment is not necessary because the type of comment is only one.

If it is judged in step S205 that the additional information concerns a style change, the information reflector 402 proceeds to step S206. In step S206, the information reflector 402 adds reference tags of the CSS file 520 to the accessed page and sends the resulting page.

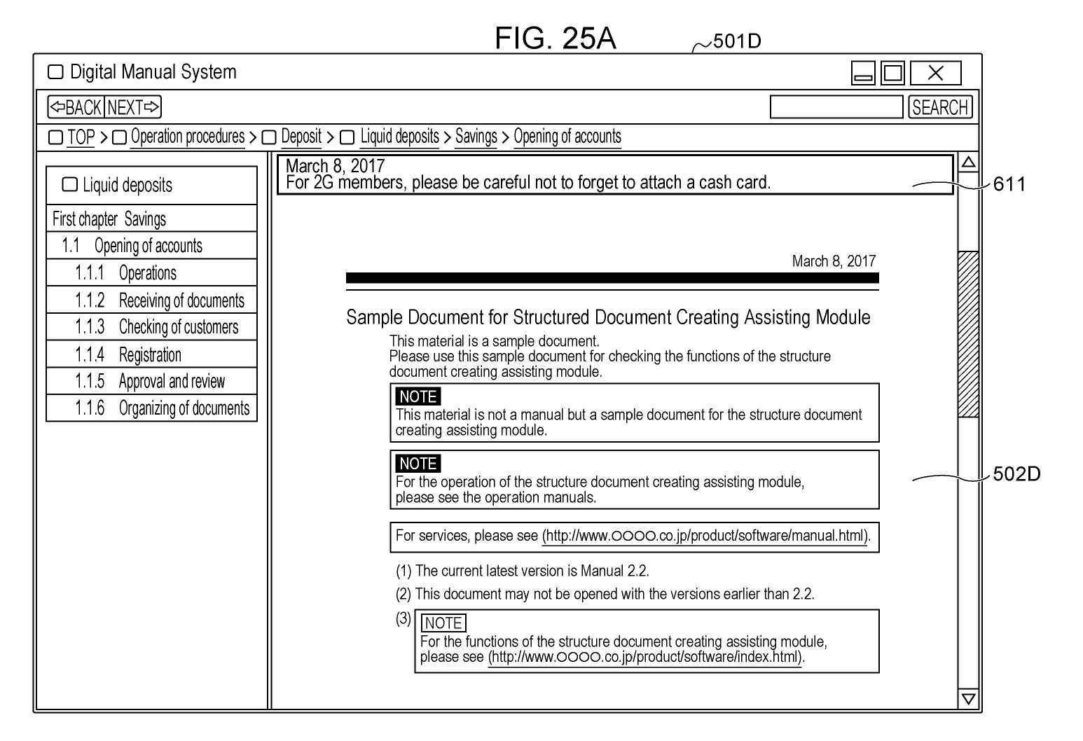

FIGS. 23A and 23B illustrate examples of user interface screens when additional information concerning a style change is appended to the accessed page. FIG. 23A illustrates an example of a user interface screen 501A of a user permitted to read the additional information (authorized user). FIG. 23B illustrates an example of a user interface screen 501B of a user who is not permitted to read the additional information (unauthorized user).

The content of a page 502B displayed on the user interface screen 501B is the same as the page read from the manual DB 403 (see FIG. 7).

In contrast, a comment 611 is added to a page 502A displayed on the user interface screen 501A, and the display style of a portion 612 has been changed by the additional information.

In this exemplary embodiment, the comment 611 is constituted by a message “Mar. 8, 2017 (line break) For 2G members, please be careful not to forget to attach a cash card”. The comment 611 is displayed on the top portion of the display area of the page 502A of the user interface screen 501A.

In this exemplary embodiment, the content of the portion 612 on the user interface screen 501A is the same as that of the counterpart on the user interface screen 501B. However, the background color of the portion 612 is changed to red and the font type of the characters is changed to bold for attracting attention.

Referring back to FIG. 22, if it is judged in step S205 that the additional information does not concern a style change, the information reflector 402 judges in step S207 whether the additional information concerns partial-page replacement.

If it is judged in step S207 that the additional information concerns partial-page replacement, the information reflector 402 proceeds to step S208. In step S208, the information reflector 402 replaces a corresponding range of the accessed page by the attached file (html file) and sends the resulting page.

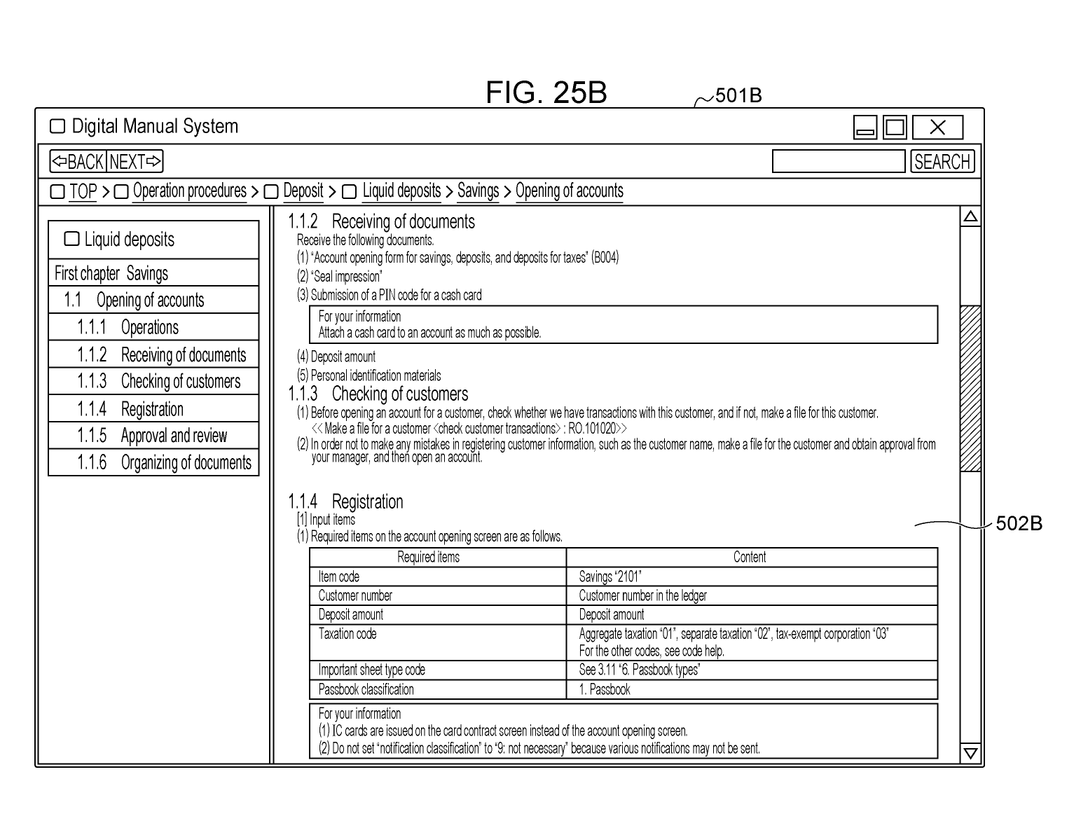

FIGS. 24A and 24B illustrate examples of user interface screens when additional information concerning partial-page replacement is appended to the accessed page. FIG. 24A illustrates an example of a user interface screen 501C of an authorized user. FIG. 24B illustrates an example of a user interface screen 501B of an unauthorized user.

The content of the page 502B displayed on the user interface screen 501B is the same as the page read from the manual DB 403 (see FIG. 7).

In contrast, a comment 611 is added to a page 502C displayed on the user interface screen 501C, and a sentence 613 is also added to the page 502C by conducting partial-page replacement based on the additional information. The content of the comment 611 is the same as that in FIG. 23A.

The sentence 613 describes “(3) Double-check received documents”. The content of the sentence 613 is the same as that shown in FIG. 15.

Referring back to FIG. 22, if it is judged in step S207 that the additional information does not concern partial-page replacement, the information reflector 402 judges in step S209 whether the additional information concerns entire-page replacement.

If it is judged in step S209 that the additional information concerns entire-page replacement, the information reflector 402 proceeds to step S210. In step S210, the information reflector 402 replaces the accessed page by the attached file (html file) and sends the resulting page.

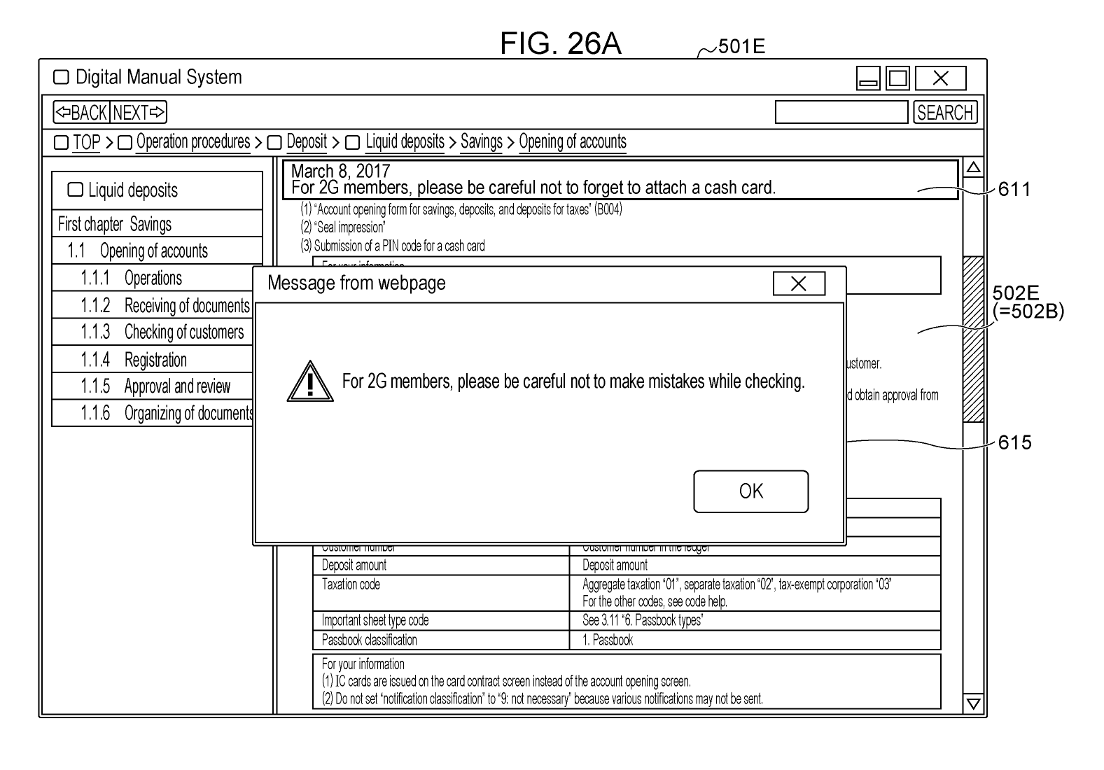

FIGS. 25A and 25B illustrate examples of user interface screens when additional information concerning entire-page replacement is appended to the accessed page. FIG. 25A illustrates an example of a user interface screen 501D of an authorized user. FIG. 25B illustrates an example of a user interface screen 501B of an unauthorized user.

The content of the page 502B displayed on the user interface screen 501B is the same as the page read from the manual DB 403 (see FIG. 7).

In contrast, the content of a page 502D displayed on the user interface screen 501D is totally different from that of the user interface screen 501A or 501C, though a comment 611 is displayed, as in the user interface screens 501A and 501C.

Referring back to FIG. 22, if it is judged in step S209 that the additional information does not concern entire-page replacement, the information reflector 402 judges in step S211 whether the additional information concerns a script.

If it is judged in step S211 that the additional information concerns a script, the information reflector 402 proceeds to step S212. In step S212, the information reflector 402 embeds the script in the accessed page and sends the resulting page.

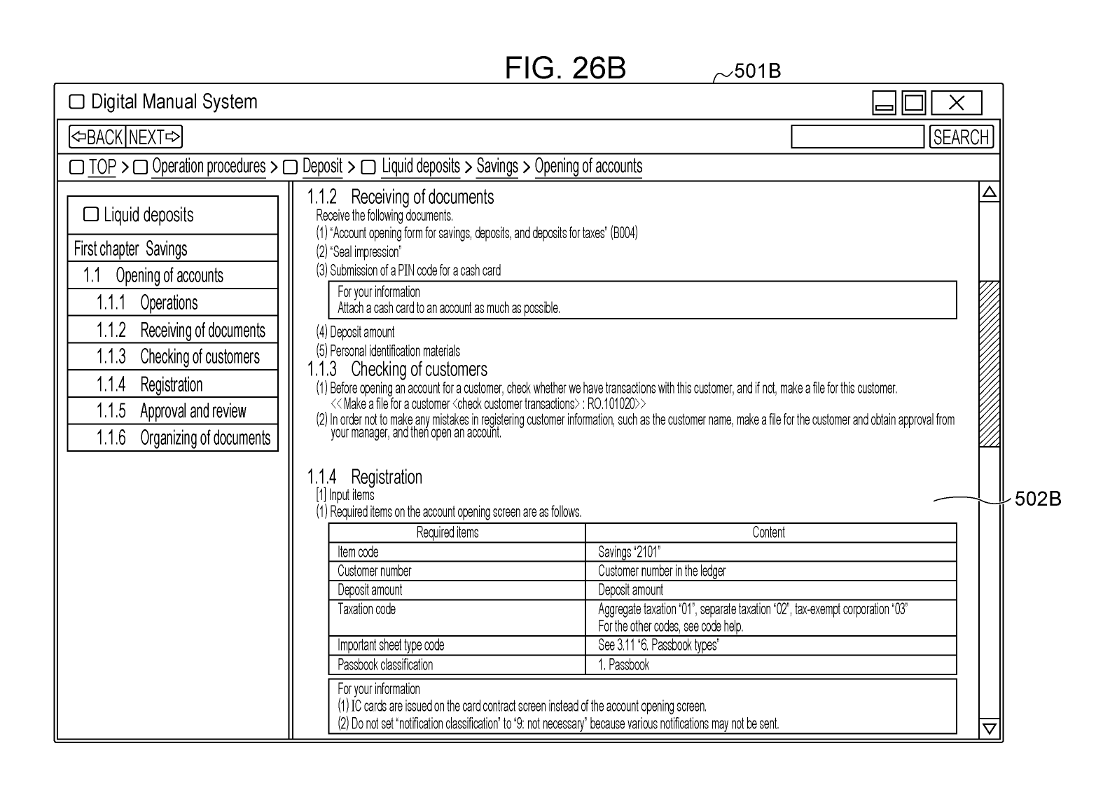

FIGS. 26A and 26B illustrate examples of user interface screens when additional information concerning a script is appended to the accessed page. FIG. 26A illustrates an example of a user interface screen 501E of an authorized user. FIG. 26B illustrates an example of a user interface screen 501B of an unauthorized user.

The content of the page 502B displayed on the user interface screen 501B is the same as the page read from the manual DB 403 (see FIG. 7).

The content of a page 502E displayed on the user interface screen 501E is the same as that of the page 502B. However, a comment 611 and a popup 615 are added to the page 502E. In this exemplary embodiment, the popup 615 is an alert message “For 2G members, please be careful not to make mistakes while checking”.

The reading system 1 according to this exemplary embodiment allows relevant users to read a digital manual appended with additional information or a comment without changing original data concerning the digital manual.

The reading system 1 according to this exemplary embodiment makes it possible to display a digital manual to which a change has been made, unlike the content in which an underline or a remark is merely added to a digital manual.

The reading system 1 according to this exemplary embodiment provides the comment management DB 302 and the additional information management DB 304 independently of the manual DB 403 storing original data concerning a digital manual. This minimizes the need to remake a comment or additional information to be appended to the original data. In other words, a digital document and a change to be made to the digital document are separately managed.

### Other Exemplary Embodiments

The exemplary embodiment of the invention has been discussed. However, the technical scope of the invention is not restricted to the above-described exemplary embodiment. Various modifications and improvements may be made, and exemplary embodiments based on such modifications and improvements are also encompassed within the technical scope of the invention.

For example, in the above-described exemplary embodiment, the range of users to be permitted to read a comment or additional information appended to a digital manual is restricted (see step S105 of FIG. 8). However, the range of such authorized users may not necessarily be restricted. In this case, any user accessed a digital manual can read a comment or additional information appended to a digital manual. This configuration still allows the users to read a digital manual in which a change made to an element (characters, phrases, sentences, drawings, photos, part of a page, and the entirety of a page, for example) forming the digital manual is reflected without changing original data concerning the digital manual.

In the above-described exemplary embodiment, the range of authorized users is selected by checking a corresponding check box. However, a selection button may be used instead of a check box.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process, the process comprising:
receiving addition of a file representing information for providing a change to be made to an element forming a digital document to be read;
managing the information by linking the information with the digital document; and
presenting the digital document in which the information is reflected.

2. The non-transitory computer readable medium according to claim 1, wherein the information indicates at least one of a document which replaces part of the digital document, a document which replaces entirety of the digital document, and a program for providing an instruction to make a change to the element.

3. The non-transitory computer readable medium according to claim 2, wherein an extension is appended to the file in accordance with a type of the information.

4. The non-transitory computer readable medium according to claim 1, wherein the file is linked with a comment which will be displayed as a popup or a note.

5. The non-transitory computer readable medium according to claim 1, wherein a screen which assists in inputting of the information is displayed.

6. The non-transitory computer readable medium according to claim 1, wherein a range of readers to be permitted to read the information is selected by an input operation.

7. The non-transitory computer readable medium according to claim 6, wherein the range of readers is selected by using one of or a combination of an individual, a group, an organization, a position in an organization, a project, a client, a terminal device, and position information.

8. The non-transitory computer readable medium according to claim 1, wherein the information and a range of readers to be permitted to read the information to be linked with the digital document are managed in a storage area different from a storage area of the digital document.

9. A non-transitory computer readable medium storing a program causing a computer to execute a process, the process comprising:
judging whether a file representing information for providing a change to be made to an element forming a digital document to be read is linked with the digital document;
judging, if the file is linked with the digital document, whether a subject reader is a reader permitted to read the digital document in which the information is reflected; and
presenting the digital document in which the information is reflected if the subject reader is permitted to read the digital document in which the information is reflected and presenting the digital document in which the information is not reflected if the subject reader is not permitted to read the digital document in which the information is reflected.

10. The non-transitory computer readable medium according to claim 9, wherein judging of whether the file is linked with the digital document is made by accessing a storage area different from a storage area of the digital document.

11. An information processing apparatus comprising:
a receiver that receives addition of a file representing information for providing a change to be made to an element forming a digital document to be read;
a manager that manages the information by linking the information with the digital document; and
a presenter that presents the digital document in which the information is reflected.
